(19) United States
(12) Patent Application Publication
(10) Pub. No.: US 2004/0011917 A1
(43) Pub. Date: Jan. 22, 2004

(54) Shock wave modification via shock induced ion doping

(76) Inventors: Richard E. Saeks, Chattanooga, TN (US); John J. Mankowski, Lubbock, TX (US); Frances Vine, Chattanooga, TN (US); Steven M. Cooper, Ooltewah, TN (US); Robert M. Pap, Chattanooga, TN (US)

Correspondence Address: Eric P. Schellin, Suite 704, 2121 Crystal Drive, Arlington, VA, 22202, US

(21) Appl. No.: 10/265,265

(22) Filed: Oct. 7, 2002

Related U.S. Application Data
(60) Provisional application No. 60/396,563, filed on Jul. 18, 2002.

(51) Int. Cl. B64C 1/00

(52) U.S. Cl. 244/1 N

(57) ABSTRACT

The present invention relates to an apparatus and method which partially ionizes a portion of the gas flow through a shock wave, employing the electrostatic forces produced by the resultant ion doped region in and behind the shock wave to reduce the intensify of the shock wave. Such a method or apparatus is detailed to be employed at the tips of a rotating compressor or turbine blade; to the flow through a gas duct in an aircraft engine inlet; at the tips of a propeller or rotorcraft blade or on the surfaces or an aircraft.

### RELATED PATENT APPLICATIONS

This application depends on Provisional patent application 60/396,563 filed Jul. 18, 2002

### FIELD OF THE INVENTION

The herein disclosed invention relates to an apparatus and method which partially ionizes the gas present in a gaseous shock wave to reduce the magnitude and the intensity of the shock wave. It is contemplated that such an apparatus and method can be employed at the tips of a rapidly rotating compressor or turbine blade; to the flow through a gas duct; at an aircraft engine inlet; at the tips of a propeller; or at the tips of a rotorcraft blade and, further, on the leading edges and surfaces of aircraft and missiles.

By way of background, it is noted that a shock wave is a mechanical wave of large amplitude, propagating at supersonic velocity, across which pressure or stress, density, particle velocity, temperature, and related properties change in a nearly discontinuous manner. Unlike acoustic waves, shock waves are characterized by an amplitude-dependent wave velocity. It is known that shock waves arise from sharp and violent disturbances generated from a lightening stroke, bomb blast or other form of intense explosion and from steady supersonic flow over bodies. The present invention is primarily concerned with shock waves in gases, although the disclosed invention may have applicability in condensed materials.

The abrupt nature of a shock wave in a gas can best be visualized from a schlieren type photograph or shadow graph of supersonic flow over objects. It has been observed that such photographs show well-defined surfaces in the flow field where the density changes rapidly, in contrast to waves within the range of linear dynamic behavior of the fluid. Measurements of fluid density, pressure, and temperature across the surfaces show that these quantities always increase along the direction of flow, and that the rates of change are usually so rapid as to be beyond the spatial resolution of most instruments. These surfaces of abrupt change in fluid properties are called shock waves or shock fronts.

Shock waves in supersonic flow may be classified as normal or oblique according to whether the orientation of the surface of abrupt change is perpendicular or at an angle to the direction of flow. The produced shock wave assumes an approximately parabolic shape and may be detached from the solid object about which the gaseous stream flows. The central part of the wave, i.e., just in front of the solid object is the normal shock; the outer part radiating therefrom is an oblique shock wave of gradually changing obliqueness and strength.

In a normal shock wave the changes in thermodynamic variables and flow velocity across the shock wave are governed by the laws of conservation of mass, momentum, and energy, and also by the equation of state of the fluid. For the case of a normal shock, the mass flow and momentum equations are the same as for an acoustic wave. However, in a shock wave, changes in pressure P and density p across the wave front cannot be considered small. As a consequence, the velocity of propagation of the shock wave relative to the undisturbed fluid is given by the following equation:

$${u}_{1}^{2} = \frac{{p}_{2} ( {P}_{2} - {P}_{1} )}{{p}_{1} ( {p}_{2} - {p}_{1} )} \qquad Eq 1$$

where the initial state of the fluid is denoted by subscript 1 and variables behind the shock front are denoted by subscript 2. In addition, conservation of thermal and kinetic energy across the shock front requires the validity of the following equation:

b₁+u₁₂/2=b₂+u₂²/2 Eq 2

wherein b is the specific enthalpy (or total heat per unit mass) of the fluid and u₁ an u₂ are fluid velocities relative to the shock wave. By eliminating u₂ and u₁ with the aid of Eq (1) and the law of the conservation of mass the energy equation becomes Eq 3:

$${b}_{2} - {b}_{1} = \frac{1}{2} ( \frac{1}{{p}_{1}} + \frac{1}{{p}_{2}} ( {P}_{2} - {P}_{1} ) \qquad Eq 3$$

There, it follows that shock waves always travel at supersonic speeds relative to the fluids into which they propagate.

The changes in flow variables across an oblique shock wave are governed by the laws of conservation of mass, momentum, and energy in a coordinate system which is stationary with respect to the shock front. In this case, the problem is slightly complicated by the fact that the flow velocity will experience a sudden change of direction as well as magnitude in crossing the shock.

The present invention is an improvement of the ion doping method for aerodynamic flow control taught in U.S. Pat. No. 6,247,671 issued Jun. 19, 2001, entitled “Ion Doping Apparatus and Method for Aerodynamic Flow Control.”

As was stated in the above, when a flow accelerates to supersonic speeds it must pass through a shock wave to return to static conditions. At the shock wave, it is taught that the velocity of the flow abruptly drops from supersonic to subsonic, while the pressure, density and temperature of the flow abruptly increases. This, then, may in turn, have a detrimental effect on the performance of the underlying system, generating noise, vibrating and mechanical stresses at the tip of a turbine blade, propeller, or rotorcraft blade; dramatically increasing aerodynamic drag and the temperature to which an aircraft or missile is subjected, and producing a sonic boom associated with a supersonic aircraft. An apparatus or method for eliminating or reducing the intensity of a shock wave can significantly enhance the performance of an aircraft, missile, rotorcraft, turbine or an air duct.

### DESCRIPTION OF THE PRIOR ART

Traditionally system designers attempt to deal with the problems resulting from a shock wave by optimizing the geometry of an air vehicle, blade, or duct to minimize the intensity of the resultant shock waves. The use of geometric techniques is, however, limited by the performance requirements for the overall system, structural strength, volumetric efficiency, and flow rates.

Conventional aerodynamics teaches that the magnitude of a shock wave can be reduced by heating the impinging gas flow, which increases the speed of sound in the gas, thereby reducing the Mach number of the flow and the intensity of the resultant shock wave. Unfortunately, the energy required to heat the gas is usually too large to yield an energy efficient apparatus or method for reducing the intensity of a shock wave. V. V. Kuchinsky, [32rd AIAA Plasmadynamics and Lasers Conference, Los Angeles, June 2001] postulated that the same effect can be achieved by locally heating the gas flow in the vicinity of the shock wave but does not describe an apparatus or method for implementing such a system.

In U.S. Pat. Nos. 5,791,599 and 5,797,563 both to R. F. Blackburn et al; uses an electromagnetic energy source in the microwave range to reduce the mass density of the medium through which a vehicle is moving, thereby reducing the drag fores acting on the vehicle and the magnitude of the associated shock waves. Another prior art system, disclosed by W. A. Donald in U.S. Pat. No. 3,446,464, postulates reducing the mass density of the medium through which an air vehicle is moving, by accelerating the air molecules rearwardly from the leading edges of the aircraft with an electric field, thereby reducing the intensity of the associated shock waves, and the drag acting on the vehicle.

Z. T. Deng, et al [33^{rd} AIAA Plasmadynamics and Laser Conference, Maui, May 2002] teach that a force applied to a shock wave in the direction opposite the flow will reduce the intensity of the shock wave. J. Shang [AIAA Paper 99-0336, 37th AIAA Aerospace Sciences Meeting and Exhibit, Reno, 1999] teaches that the Lorentz force produced by an externally imposed magnetic field acting on a plasma in the vicinity of a shock wave will reduce the intensity of the shock wave. H. Yamasaki, et al [Proc. Of the IVTNN Workshop on Weakly Ionized Plasma, p.p. 105-111, Moscow, 2001] teach that such a Lorentz force combined with heating will reduce the intensity of the shock wave

US. Pat. No. 3,162,398 to Cluser et al teaches that the force produced when a magnetic field interacts with the naturally produced plasma surrounding a high velocity flight vehicle can be used to change the position of the shock wave, reduce the heat at the surface of the flight vehicle and/or steer the vehicle, while C. M. Cason III in U.S. Pat. No. 3,392,941 teaches that the force produced when a magnetic field interacts with the naturally produced plasma surrounding a nosecone or reentry vehicle can be used to steer the nosecone.

In U.S. Pat. No. 6,247,671 Saeks et al teach that the intensity of a shock wave can be reduced by the electrostatic forces produced by an ion doped (ion rich) region in and behind the shock wave. The present invention improves upon U.S. Pat. No. 6,247,671 by providing a method and apparatus which exploits the properties of the shock wave to efficiently produce an ion doped region and control its location in and behind the shock wave.

### SUMMARY OF THE INVENTION

The present invention is in regard to an apparatus which partially ionizes the gas in the vicinity of a shock wave; ionizing one gas molecule in ten to as few as one gas molecule in a billion. As is the case with the neutral gas molecules, the temperature of the free electrons produced by the partial ionization process jumps abruptly, by a factor of 1.5 to 5, depending on the Mach number of the flow, as the flow passes through the shock wave and then gradually declines behind the shock wave, as the free electrons collide with neutral gas molecules and ions.

The hot electrons, which are created when the partially ionized gas passes through the shock, collide with neutral gas molecules near the shock wave thereby increasing the ionization level in and behind the shock wave by an order of magnitude or more. Due to their small size the free electrons produced by this additional ionization process diffuse rapidly into the neutral gas, while the larger ions remain concentrated in and behind the shock wave thereby producing an ion doped region in and behind the shock wave.

Since the electron temperature rises abruptly through the shock wave and then decays gradually behind the shock wave, the rise in electron temperature and the resulting ion doped region is asymmetric about the shock occurring primarily in and behind the shock wave. As such, the repulsive forces between the ions in the doped region produce a net electrostatic force in the direction opposite to the flow at the shock wave. This force, in turn, reduces the intensity of the shock wave as taught by Saeks et al in U.S. Pat. No. 6,247,671.

Such an apparatus has a two-fold advantage as compared to the electromagnetic shock wave modification techniques in the prior art. First, since the apparatus is only required to partially ionize the gas flow in the vicinity of the shock wave, the energy requirements of the present invention are significantly reduced as compared to the energy required by an apparatus which fully ionizes the gas flow. Secondly, the location of the ion doped region in and behind the shock wave is determined by the position of the shock wave. As the position of the shock wave may change when its intensity is reduced and/or the aerodynamic environment changes, this alleviates the necessity of implementing a mechanism in the apparatus to track the position of the shock wave.

### BRIEF DESCRIPTION OF THE DRAWINGS

FIG. 1 is a graph which illustrates the rapid electron temperature rise across the shock wave and gradual decay behind the shock wave.

FIG. 2 is a graph which illustrates ion doping in and behind the shock wave.

FIG. 3 is a schematic front view of a jet turbine showing plasma torches.

FIG. 3A is a schematic view of a detailed view of an applicable plasma torch.

FIG. 4 is a schematic view of a rotorcraft showing blades with a planar generator.

FIG. 4A is schematic of an inverter.

FIG. 4B is a schematic of a planar generator.

FIG. 5 is a schematic of an aircraft showing wing surfaces fitted with plasma generators.

FIG. 5A is a schematic of an invertor.

FIG. 5B is a schematic of a planar generator.

FIG. 6 is a schematic of a duct which is subjected to internal gas flow.

FIG. 6A is the duct of FIG. 6 shown as being encompassed by a microwave device.

FIG. 7 is a schematic of a nose cone being fitted with a plasma generating means.

FIG. 8 is a schematic of an aircraft with planar generators affixed to its leading edges.

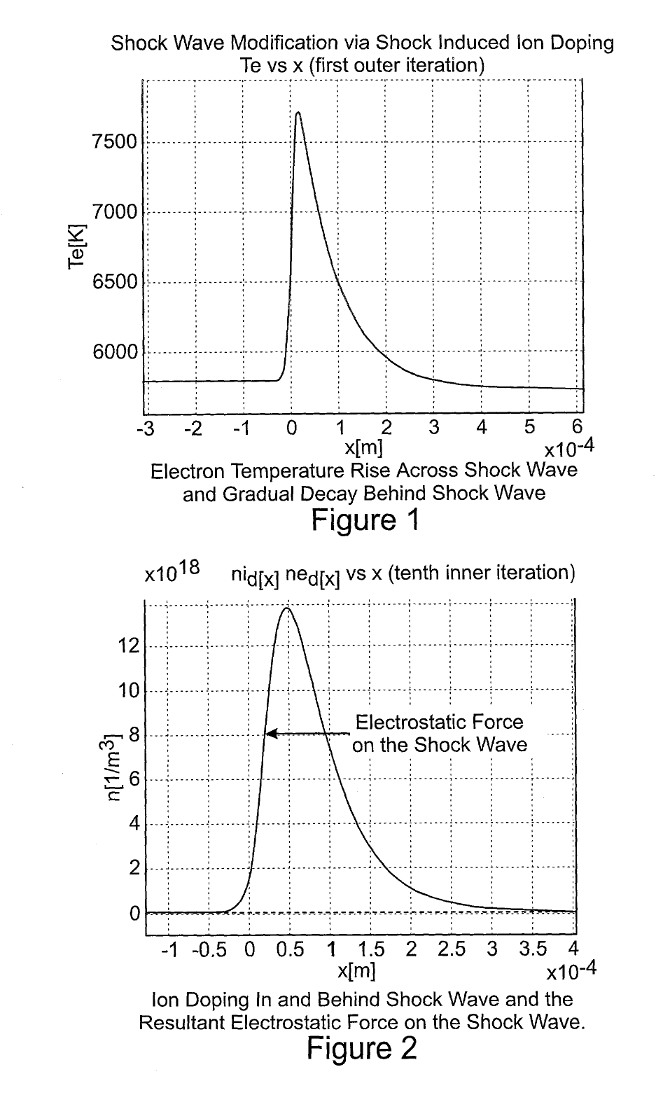

### DETAILED DESCRIPTION OF THE PREFERRED EMBODIMENTS

The first embodiment, typically depicts the invention detailed to reduce the shock waves at the tip of a conventional compressor or turbine blade as illustrated in FIG. 3. Here, the compressor or turbine blades 11 are mounted on a hub 12 and rotate within a housing 13, with the tips of the blades moving at or above the speed of sound, producing shock waves which cause noise, vibration and mechanical stress on the compressor or turbine blades, limiting the speed at which the compressor or turbine can operate.

An array of microwave plasma torches 14 is mounted externally on the compressor or turbine housing 13 tangentially oriented to produce a partially ionized plasma 15 in the vicinity of the outermost tips of the blades.

As can be seen from FIG. 3A each plasma torch 14 is powered by a primary (AC or DC) power source 17 which drives a microwave source 18, typically employing a magneton. The microwave source 18 generates a microwave signal which propagates through a waveguides 19 to a microwave cavity 20. A working gas 21, typically argon or compressed air, flows in a tube 22, through the microwave cavity 20, where it is ionized, and then ducted through a nozzle 23, producing a plasma 16.

The plasma plumes 16 produced by the array of plasma torches 14 mounted on the compressor or turbine housing 13 mix with the air inside the housing 13 proximate the tips of the blades 11 to produce the required partially ionized plasma 15 at the tips of the compressor or turbine blades 11, while the ionization level of the resultant partially ionized plasma 15 is controlled by the power level of the microwave source 18 and the flow rate of the working gas 21. The shock waves at the tips of the compressor or turbine blades then induce ion doped regions in and behind the shock waves and the resultant electrostatic forces reduce the intensity of the shock waves at the tips of the blades 11. Alternatively in this embodiment, the array of microwave plasma torches in FIG. 3A can be substituted by an array of erosive (ablative) plasma torches as taught by Saeks et al in U.S. Pat. No. 6,247,671.

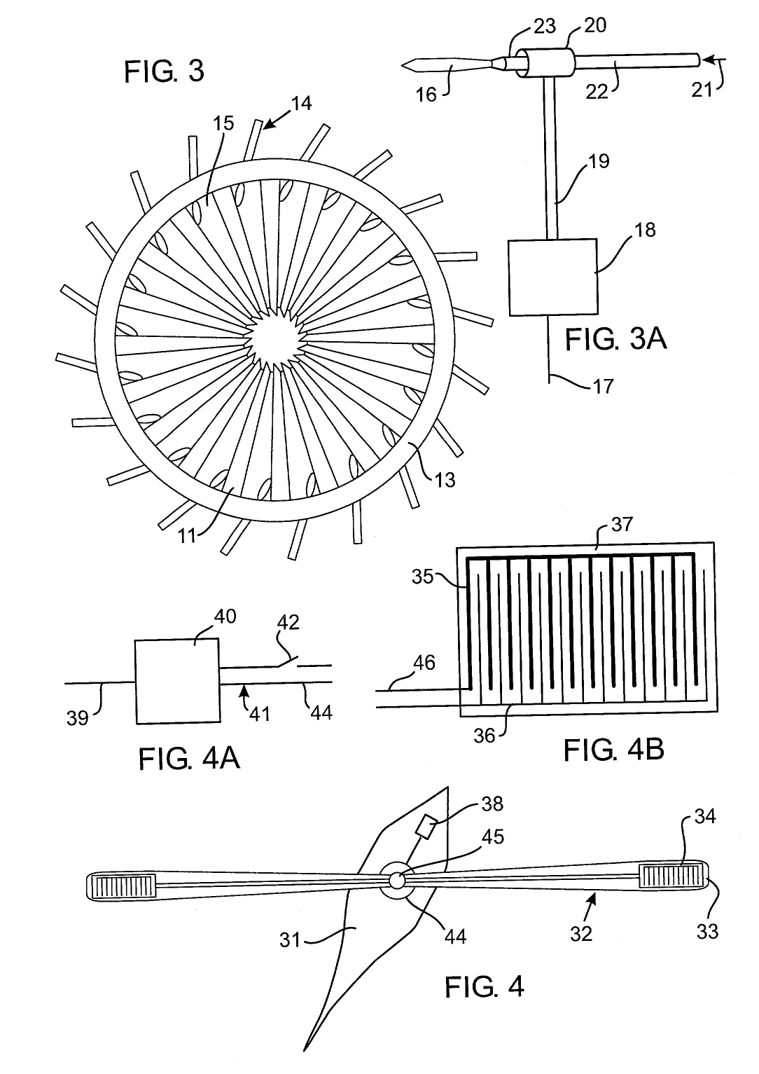

A second embodiment of the invention, designed to reduce the intensity of the shock waves at the tip of the advancing rotor blade of a rotorcraft, can be seen in FIGS. 4 and 4A. Although a rotorcraft 31 typically flies at well below the speed of sound, the combination of the forward velocity of the rotorcraft 31 with the forward velocity of the advancing rotor blade 32 may produce a supersonic flow at the tip of the advancing rotor blade 33. The resultant shockwave at the rotor blade 33, thus limiting the performance of the rotorcraft 31.

To reduce the intensity of these shock waves, a planar plasma generator 34 is located at the tip of each rotor blade 33 mounted flush with the surface of the rotor blade 32. The planar plasma generator 34 is composed of an outside electrode 35 and an inside 36 electrode mounted on a ceramic substrate 37. Each electrode is composed of fingers, with the fingers on the outside electrodes 35 and the inside electrodes 36 interlaced as depicted in FIG. 4A, while the ceramic material used for the substrate 37 is selected to prevent electrical breakdown.

The power supply 38 for the planar plasma generator 34 is powered by an (AC or DC) primary power source 39 which drives an inverter 40, generating a 5-10 kV square wave output 41 in the 10-100 kH_{z} frequency range. The output of the inverter 41 is passed through a switch 42, which closes when the tip of the rotor blade is moving forward, cables 43, and slip rings 44 at the hub of the rotor blade 45 to the input 46 of the planar plasma generator 34. When the square wave signal 41 from the inverter 40 is applied to the electrodes 35 and 36 it produces a plasma on the surface of the planar plasma generator 34, which partially ionizes the air near the surface of the tip of the rotor blade 33, while the ionization level of the resultant partially ionized plasma is controlled by the inverter voltage. The shock wave then induces an ion doped region in and behind the shock and the resultant electrostatic forces reduce the intensity of the shock wave at the tip of the advancing rotor blade 33.

Alternatively, in this embodiment one may replace the inverter 40 located inside the rotorcraft 31 with an inverter located in the hub of the rotor blade 45 or with separate inverters 40 located in the base of each rotor blade 32 to eliminate passing the square wave output 41 of the inverter 40 through the slip rings 44 at the hub 45 of the rotor blade 32. Furthermore, one may replace the planar plasma generators by erosive plasma torches at the tips of the rotor blades and the inverter with a DC power supply Additionally, one may then use a similar system at the tips of a propeller blade with the switch 42 always on.

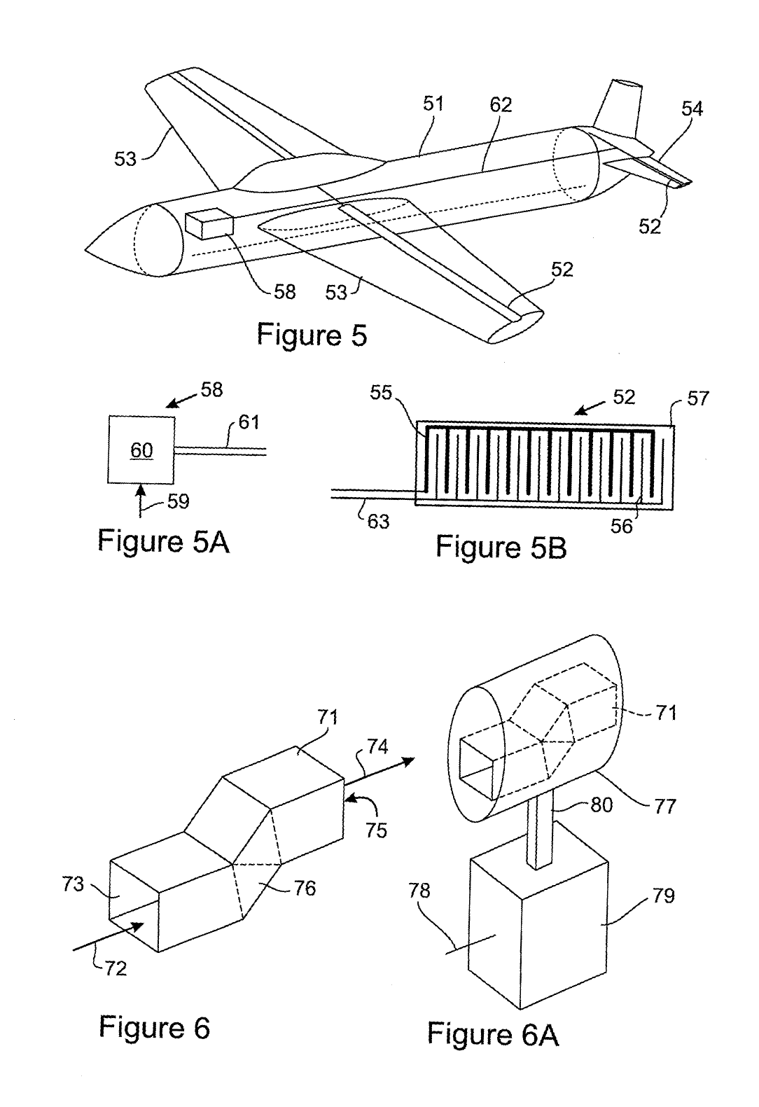

A third embodiment of the invention to reduce the intensity of the shock waves which result from the local supersonic flow on the top of the wings, tail, and other surfaces of an aircraft 51 flying at transonic speed (ie., near the speed of sound) is depicted in FIGS. 5, 5A and 5B. When an aircraft flies at or near the speed of sound, local supersonic flows, which produce shock waves, occur along the surfaces of the aircraft, typically on the top of its wings and/or tail. These shock waves increase the drag in the aircraft in this speed range, limiting the maximum speed at which a subsonic aircaft can efficiently cruise, and increasing the thrust required for a supersonic aircraft to pass through the speed of sound.

To reduce the intensity of these shock waves, planar plasma generators 52 are located on top of the wings 53, tail 54 and/or other surfaces of the aircraft where the transonic shock waves occur, mounted flush with the surface. The planar plasma generators 52 are composed of an outside 55 electrode and an inside electrode 56 mounted on a ceramic substrate 57. Each electrode is composed of fingers, with the fingers on the outside electrode 55 and the inside electrode 56 interlaced as shown in FIG. 5B, while the ceramic material used for the substrate 57 is selected to prevent electrical breakdown.

The power supply 58 for the planar plasma generators 52 is powered by a primary (AC or DC) source 59 which drives an inverter 60, generating a 5-10 kV square wave output 61 in the 10-100 kH_{z} frequency range. The output from the inverter 61 is passed through cables 62 to the input 63 of the planar plasma generators 52. When the square wave signal 61 from the inverter 60 is applied to the electrodes 55 and 56 it produces a plasma on the surface of the planar generators 52, which partially ionizes the air on top of the wings 53, tail 54 and/or other surfaces of the aircraft where the transonic shock waves occur, while the ionization level of the resultant partially ionized plasma is controlled by the inverter voltage. The shock waves on top of the wings 53, tail 54, and/or other surfaces of the aircraft, then induce ion doped regions in and behind the shock and the resultant electrostatic forces reduce the intensity of the shock waves.

Alternatively, in this embodiment the planar plasma generators may be replaced by an array of microwave plasma torches embedded on top of the wings 53, tail 54 and/or other surfaces of the aircraft, where the transonic shock waves occur, and a microwave source; or an array of erosive plasma torches embedded on top of the wings 53, tail 54, and/or other surfaces of the aircraft where the transonic shock waves occur, and a DC power supply.

The fourth embodiment of the invention is designed to reduce the shock waves in a duct or aircraft engine inlet 71 as depicted in FIGS. 6 and 6A. Here, the incoming supersonic or subsonic gas flow 72 enters the duct or inlet 71 through its entrance 73, with the outgoing supersonic or subsonic flow 74 exiting though the exit 75. Depending on its geometry, shock waves 76 may be generated in the duct or inlet 71 decreasing the velocity of the gas flow to (possibly) subsonic speeds at the exit 75. Indeed, many engine inlets are intentionally designed to produce shock waves to reduce the flow velocity from supersonic to subsonic. The shock waves 76 in a duct or engine inlet 71, however, increase the pressure and density of the gas flow behind the shock waves, and, as such, one may desire to minimize their intensity.

To reduce the intensity of these shock waves, a duct or engine inlet 71, made of non-metallic material, is embedded inside a microwave cavity 77 which generates a partially ionized plasma in the duct or engine inlet 71. The microwave energy required to produce this plasma is generated by a primary (AC or DC) power source 78 which drives a microwave source 79, typically employing a magneton. The microwave source 79 generates a microwave signal which propagates through a waveguide 80 to the microwave cavity 77. The resultant microwave signal partially ionizes the gas in the cavity 77 including the gas in the duct or engine inlet 71, while the ionization level of the resultant partially ionized plasma is controlled. by the power level of the microwave source 79. The shock waves then induce ion doped regions in and behind the shock waves and the resultant electrostatic forces reduce the intensity of the shock waves in the duct or engine inlet 71.

Alternatively, in this embodiment the microwave source 79 can be replaced by a radio frequency oscillator and power amplifier, typically in the 3-30 MH_{z} band, while the waveguide 80 is replaced by a transmission line and the microwave cavity 77 is replaced by an inductor wrapped around the duct or engine inlet 71. The resultant radio frequency plasma generator is then used to generate a partially ionized plasma in the duct or engine inlet 71. The shock waves then induce ion doped regions in and behind the shocks and the resultant electrostatic forces reduce the intensity of the shock waves in the duct or engine inlet 71.

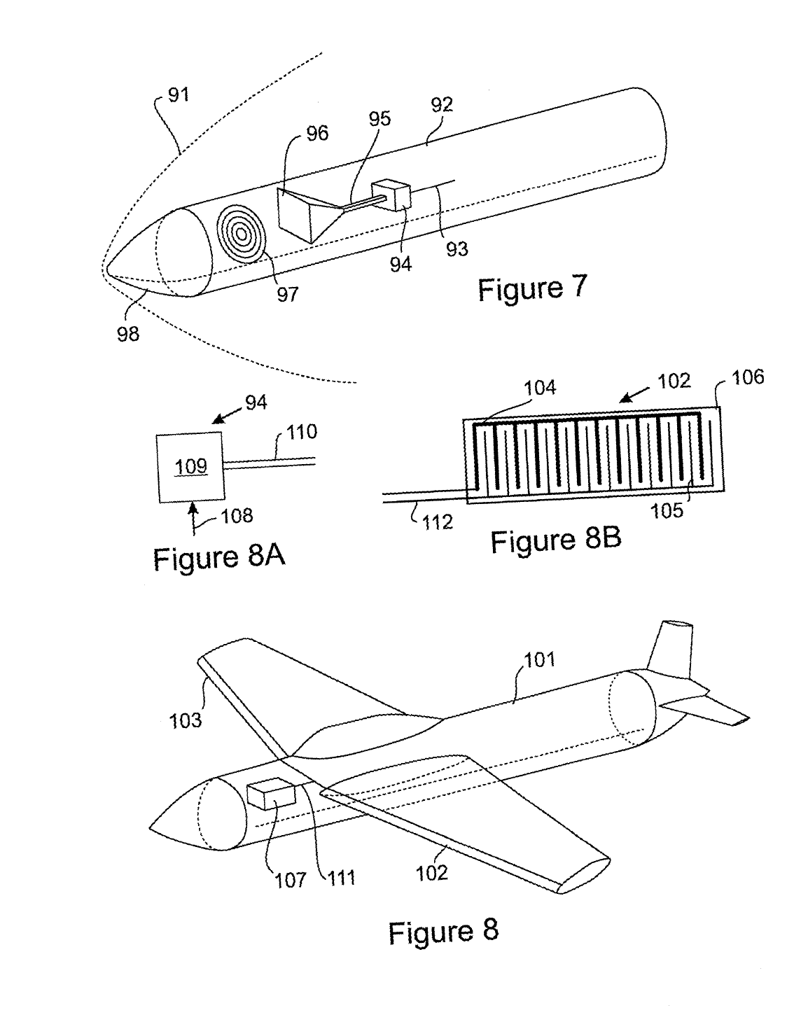

The fifth embodiment of the invention is to reduce the shock waves 91 in front of a supersonic missile 92 or aircraft is illustrated in FIG. 7. When a missile or aircraft exceeds the speed of sound, shock waves are produced ahead of the missile or aircraft nosecone. These shock waves raise the gas pressure, density, and temperature at the nosecone, increasing the missile or aircraft drag and the temperature of the material from which the missile or aircraft is manufactured, limiting the speed at which the missile or aircraft can operate.

In this fifth embodiment a primary (AC or DC) power source 93 drives a microwave source 94, typically employing a magneton. The microwave source 94 generates a microwave signal which propagates through a waveguide 95 to a microwave antenna 96. The antenna projects the microwave signal through a microwave lens 97, which focuses the signal through a microwave transparent nose cone 98 into the vicinity of the shock wave 91.

This partially ionizes the gas flow in the vicinity of the shock waves 91, while the ionization level of the resultant partially ionized plasma is controlled by the power level of the microwave source 94. The shock wave 91 ahead of the nosecone 98 then induces an ion doped region in and behind the shock, while the resultant electrostatic forces reduce the intensity of the shock wave 91.

Alternatively, in this embodiment the microwave antenna and lens may be replaced by an array of microwave plasma torches embedded in the missile or aircraft nosecone, or the microwave source, antenna, and lens may be replaced by an array of erosive plasma torches embedded in the missile or aircraft nosecone and a DC power supply.

A sixth embodiment of the invention, as shown in FIG. 8, to reduce the shock waves in front of the leading edges of a supersonic aircraft 101 or missile is illustrated in FIG. 8. As stated in the above when an aircraft or missile exceeds the speed of sound, sock waves are produced ahead of the leading edges of the aircraft or missile wings, tail, and/or rudders. These shock waves raise the gas pressure, density, and temperature at the leading edges, increasing the missile or aircraft drag and the temperature of the materials from which the leading edges of the aircraft or missile are manufactured, limiting the speed at which the missile or aircraft can operate.

To reduce the intensity of these shock waves planar generators 102 are located at the leading edges 103 of the wing, tail, and/or rudder, mounted flush with the surface. The planar plasma generators 102 are composed of an outside electrode 104 and an inside electrode 105 mounted on a ceramic substrate 106. Each electrode is composed of fingers, with the fingers on the outside electrode 104 and the inside electrode 105 interlaced as illustrated in FIG. 8B, while the ceramic material used for the substrate 106 is selected to prevent electrical breakdown.

The power supply 107 for the planar generators 102 is powered by an (AC or DC) primary power source 108 which drives an inverter 109, generating 5-10 kV square wave output 110 in the 10-100 kH_{z} frequency range. The output of the inverter 110 is passed through cables 111 to the input 112 of the planar plasma generators 102.

When the square wave signal 110 from the inverter 109 is applied to the electrodes (104 and 105) it produces a plasma on the surface of the planar plasma generators 102, which partially ionizes the gas flow near the leading edges 103 of the wings, tail, and/or rudders, while the ionization level of the resultant partially ionized plasma is controlled by the inverter voltage. The shock waves at the leading edges 103 of the wing, tail, and/or rudder, then induce an ion doped regions in and behind the shock and the resultant electrostatic forces reduce the intensity of the shock waves as taught.

Alternatively, in this embodiment the planar plasma generator may be replaced by an array of microwave plasma torches embedded in the leading edges of the aircraft or missile wings, tail, or rudders and a microwave source; or an array of erosive plasma torches embedded in the leading edges of the aircraft or missile wings, tail, or rudders and a DC power supply.

It should be noted that in all of the forging embodiments of the invention the selected plasma generators are designed to generate the requisite partially ionized plasma in the atmospheric pressure or greater environment where the given system is required to operate.

It will be appreciated that the invention may take forms other than those specifically described, and the scope of the invention is to be determined solely by the following claims.

1. A system for treating a shock wave resulting in front of a solid body when a said solid body moves through a gas at a supersonic speed comprising means to produce and introduce a partially ionized plasma into said shock wave.

2. The system of claim 1 wherein the said means comprises a plasma torch, said plasma torch includes a source of gas, said source of gas being operatively connected to a waveguide, said waveguide being operatively connected to a microwave cavity, a microwave source means adapted and constructed to impinge on said gas when in said microwave cavity to thereby ionize at least a portion of said gas, nozzle means operatively connected to said microwave cavity adapted and constructed to distribute at least partially ionized gas at least proximate said shock wave.

3. The system of claim 2 wherein the plasma torch comprises an array of plasma torches.

4. The system of claim 3 wherein the solid body comprises the tips of a plurality of turbine or compressor blades.

5. The system of claim 1 wherein the said means to produce and introduce a partially ionized plasma into a shock wave comprises a planar plasma generator which comprises interleaved electrodes on a ceramic insulator substrate, a source of electric power, said electrodes are connected to a source whereby a 5-10 kV square wave output is generated having a 10-100 kH_{z} frequency range, thereby producing a plasma on said planar plasma generator which partially ionizes the air near the surface of said solid body.

6. The system of claim 5 wherein the solid body comprises tips of blades of a rotorcraft.

7. The system of claim 5 wherein the solid body comprises surfaces of an aircraft.

8. The system of claim 5 wherein the solid body comprises leading edges of an aircraft.

9. A method for treating a shock wave thereby mitigating the intensity of a shock wave resulting in front of a solid body when said solid body moves through gas at a supersonic speed comprising generating a partially ionized gas in the proximity of said solid body comprising introducing said ionized gas in the proximity of said shock wave and into said shock wave.

10. The method of claim 9 wherein the partially ionized gas is introduced ahead of said shock wave.

11. The method of claim 10 wherein the partially ionized gas is introduced behind said shock wave.

12. The method of claim 9 wherein the partially ionized gas comprises molecules where the range of ionization is from one gas molecule in 10 to one gas molecule in a billion.

13. The method of claim 10 wherein the partially ionized gas comprises molecules where the range of ionization is from one gas molecule in 10 to one gas molecule in a billion

14. The method of claim 11 wherein the partially ionized gas comprises molecules where the range of ionization is from one gas molecule in 10 to one gas molecule in a billion.
